(19) United States
(12) Patent Application Publication
(10) Pub. No.: US 2014/0248030 A1
(43) Pub. Date: Sep. 4, 2014

(54) RECORDING DEVICE AND METHOD FOR RECORDING PROGRAM

(71) Applicant: Hon Hai Precision Industry Co., Ltd., New Taipei (TW)

(72) Inventors: PEI-YING WANG, New Taipei (TW); JIAN-SHIHN TSANG, Tu-Cheng (TW)

(73) Assignee: HON HAI PRECISION INDUSTRY CO., LTD., New Taipei (TW)

(21) Appl. No.: 14/063,191

(22) Filed: Oct. 25, 2013

(30) Foreign Application Priority Data
Mar. 1, 2013 (TW) 102107150

(51) Int. Cl. H04N 5/765

(52) U.S. Cl. CPC H04N 5/765
USPC 386/200

(57) ABSTRACT

A recording device for recording a program is provided. The recording device has a local storing unit and communicates with a network storage device. The recording unit transmits the recorded program to the network storage device, to allow users access to the network storage device to watch or download the recorded program. When the recording device is disconnected from the network storage device, the recording device stores the recorded program in the local storing unit temporarily, and then transmits the record program in the local storing unit to the network storage device when the recording device reconnects with the network storage device, to avoid the loss of the recorded program. A method for recording a program is also provided.

### BACKGROUND

1. Technical Field

The present disclosure relates to program recording technologies, and more particularly to a recording device and method for recording television (TV) programs.

2. Description of Related Art

When a user is absent or watching another program, a recording device can be used to record the TV programs, and then transmit the recorded program to a network storage device or server which communicates via a communication link. The user can then access the network storage device or server to watch the recorded TV programs at a later time. Typically however, the recording device may be disconnected from the network storage device unexpectedly during the recorded programs being transmitted, which may result in the full program not being recorded and thus any recording being useless.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a recording device communicating with a network storage device in accordance with an embodiment; the recording device includes a setting unit.

FIG. 2 is a block diagram of the setting unit in FIG. 1.

FIG. 3 is a flowchart of a method for recording a TV program in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

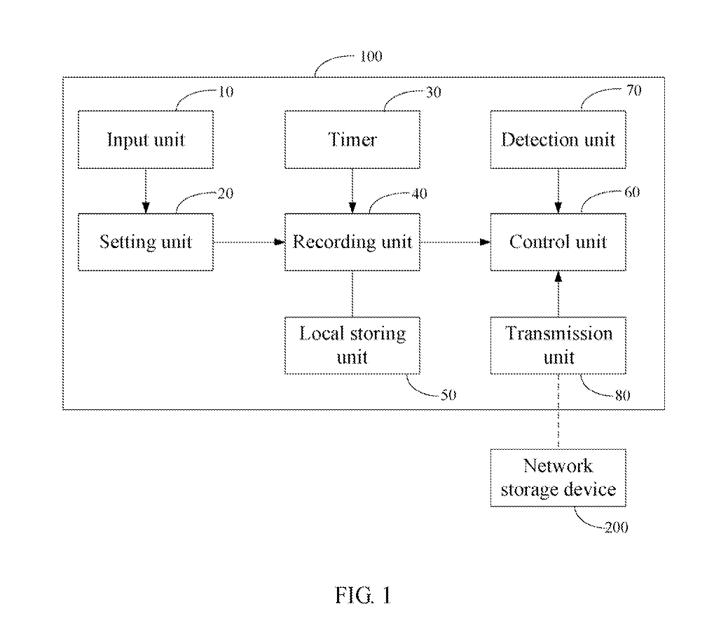

FIG. 1 shows a recording device 100 for recording, e.g., a TV program. The recording unit 100 communicates with a network storage device 200 via a communication link. The recording unit 100 transmits the recorded program to the network storage device 200, to allow user to access the network storage device to watch or download the recorded program. When the recording device 100 is disconnected from the network storage device 200, the recording device 100 stores the recorded program in a local storing unit 50 temporarily, and caches and transmits the record program in the local storing unit 50 to the network storage device 200 when the recording device 100 reconnects with the network storage device 200, to avoid loss of the recorded program. The recording device 100 can be a television, or a computer, for example. In the embodiment, the recording device 100 is a television.

The recording device 100 includes an input unit 10, a setting unit 20, a timer 30, a recording unit 40, a local storage unit 50, and a control unit 60. The recording device 100 further includes a detection unit 70 and a transmission unit 80. The transmission unit 80 intercommunicates with the network storage device 200.

The input unit 10 receives manual operations and generates instructions for controlling the recording device 100. The input unit 10 can be buttons/keys, or a touch panel mounted on a housing of the recording device 100. The input unit 10 can also be a remote control fitting for the recording device 100.

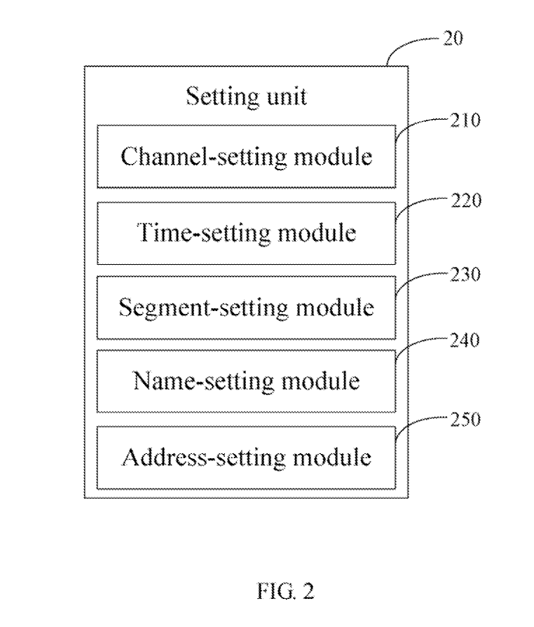

The setting unit 20 sets recording parameters in response to manual operations. The recording parameters include the desired channel corresponding to the to-be-recorded TV program, a start time S and an end time T for recording the to-be-recorded TV program, a segment condition, storing name and storing address of the to-be-recorded TV program. FIG. 2 shows that the setting unit 30 includes a channel-setting module 210, a time-setting module 220, a segment-setting module 230, a name-setting module 240, and an address-setting module 250. The channel-setting module 210 provides a channel list including a number of channels, for example, an electric program guide (EPG), for allowing users to select the desired channel. The time-setting module 220 sets the start time S and the end time T for recording the to-be-recorded TV program. The segment-setting module 230 allows users to set the segment condition. The segment condition can include a time period and a file size value. In one embodiment, the time period may be 10 minutes, and the file size value may be 10 megabytes. The name-setting module 17 sets the storing name of the segment files, such as, 001, a1, and b1 for example. When the storing name is set, the segment files could be displayed in turn with 001, 002, 003 . . . , or a1, a2, a3 . . . , or b1, b2, b3 . . . . When the transmission module 80 communicates with the network storage device 200, the address-setting module 250 sets the storing address to be the network storage device 200. When the transmission module 80 is disconnected from the network storage device 200, the address-setting module 250 sets the storing address to be the local storage device 50.

The recording unit 40 records the to-be-recorded TV program according to the recording parameters. In detail, the recording unit 40 switches to the desired channel set by the channel-setting module 210, and further records the to-be-recorded TV program when the time timed by the timer 30 reaches the start time S. When recording the TV program, the recording module 14 records the TV program according to the segment condition of the parameters. For example, if a segment condition is set to be 10 minutes, the TV program is recorded for 10 minutes and is named 001 (a1). The next TV program then starts to record for 10 minutes, and is named 002 (a2). When the last TV program is less than 10 minutes, but time reaches the end time T, the recording module 40 also stops recording, and records the last TV program as an individual segment. All the segment files can be stored in the local storing unit 50 or the network storing unit named 001, 002, 003 . . . , or a1, a2, a3 . . . .

The local storing unit 50 stores the recording parameters and the segment files. In one embodiment, the segment files are listed in turn. The local storing device can be a built-in storing medium, or an external storing device electrically connected to the recording device 100. In the embodiment, the local storage device is a built-in storing medium housed in the recording device 100.

The detection unit 70 detects whether the transmission module 80 is disconnected from the network storage device 200. When the transmission module 80 connects with the network storage device 200, the detection unit 70 generates a first signal to the control unit 60. The control unit 60 responses the first signal and transmits the recorded TV program to the network storage device 200 in real time via the transmission unit 80.

When the transmission module 80 is disconnected from the network storage device 200, the detection unit 70 generates a second signal to the control unit 60. The control unit 60 responds to the second signal and stores the recorded program to the local storing unit 50. When the detection unit 70 detects that the transmission module 80 is reconnected with the network storage device 200, the detection unit 70 generates another first signal to the control unit 60. The control unit 60 transmits the TV program recorded by the recording unit 40 in real time to the network storage device 200, and further receives and transmits the recorded TV program stored in the local storing device 50 to the network storage device 200 simultaneously. As a result, during the recording process of the TV program, when the transmission module 80 is disconnected from the network storage device 200, the recorded TV program is stored in the local storing device 50, and then is transmitted to the network storage device 200 when the transmission module 80 reconnects with the network storage device 200. Whereby the loss of the recorded TV program is avoided. Furthermore, after the recorded TV program that has been stored in the local storing unit 50 is transmitted to the network storage device 200, the control unit 60 deletes the recorded TV program that has been transmitted to the network storage device 200 to save storage space of the local storing unit 50.

When the time timed by the timer 30 reaches the end time T set by the time-setting module 220, the recording unit 40 stops recording the TV program.

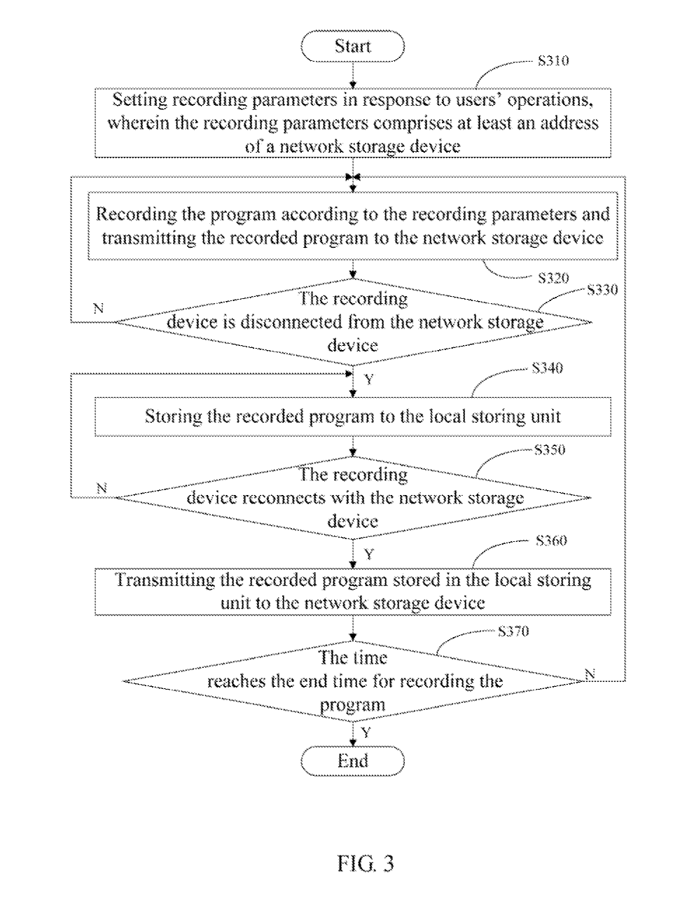

FIG. 3 is a flowchart illustrating one embodiment of a method for recording a TV program. The method is implemented by the recording device 100 communicating with the network storage device 200. The method includes the following steps:

In step S310, the setting module 20 sets the recording parameters in response to manual operations. The recording parameters includes the desired channel corresponding to the to-be-recorded program, a start time S and an end time T for recording the to-be-recorded program, the size of each section of the to-be-recorded program, storing name and address of the to-be-recorded program. In one embodiment, the recording parameters include at least an address of the network storage device 200.

In step S320, the recording unit 40 records the to-be-recorded program according to the recording parameters in real time, and the control unit 60 transmits the recorded program to the network storage device 200 via the transmission unit 80.

In step S330, the detection unit detects whether the transmission module 80 is disconnected from the network storage device 200. When the transmission module 80 stays connected with the network storage device 200, the procedure returns to step S320. When the transmission module 80 is disconnected from the network storage device 200, the procedure goes to step S340.

In step S340, the control unit 60 stores the recorded program to the local storing unit 50.

In step S350, during the recorded program being stored to the local storing unit 50, the detection unit 70 further detects whether the transmission module 80 reconnects with the network storage device 200. When the transmission module 80 reconnects with the network storage device 200, the procedure returns to step S340. When the transmission module 80 stays disconnected from the network storage device 200, and the procedure goes to step S360.

In step S360, the control unit 60 transmits the TV program recorded by the recording unit 40 in real time to the network storage device 200, and further caches and transmits the recorded TV program stored in the local storing device 50 to the network storage device 200 simultaneously.

In step S370, the control unit 60 determines whether the time timed by the timer reaches the end time set by the time-setting module 220. When the time reaches the end time, the procedure ends. When the time does not reach the end time, the procedure returns to step S320.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A recording device for recording a program, comprising;
a transmission unit communicating with a network storage device;
a local storing unit;
a setting unit for setting recording parameters in response to users' operations, wherein the recording parameters comprises at least an address of the network storage device;
a recording unit for recording the program according to the set recording parameters;
a detection unit detecting whether the transmission unit is disconnected from the network storage device; and
a control unit transmitting the recorded program to the network storage device via the transmission unit when the transmission unit connects with the network storage device, and storing the recorded program to the local storing unit when the transmission unit is disconnected from the network storage device;
wherein when the detection unit detects that the transmission unit reconnects with the network storage device, the control unit transmits the recorded program stored in the local storing unit to the network storage device.

2. The recording device of claim 1, wherein the recording parameters further comprises the desired channel corresponding to the program, a start time and an end time for recording the program, segment condition, storing name of the program.

3. The recording device of claim 2, wherein the setting unit comprises a channel-setting module for providing a channel list comprising a number of channels to allow users to select the desired channel, a time-setting module for setting the start time and the end time for recording the program, a segment-setting module for allowing users to set the segment condition, a name-setting module for setting the storing name of the recorded program, and an address-setting module for allowing users to set the storing address of the program.

4. The recording device of claim 3, wherein the segment condition comprises a time period, and the program is recorded by the recording unit for the time period.

5. The recording device of claim 3, wherein the segment condition comprises a file size value, and the program is recorded by the recording unit in the file size value.

6. The recording device of claim 1, wherein when the detection unit detects that the transmission unit reconnects with the network storage device, the control unit transmits the recorded program stored in the local storing device to the network storage device, and further transmits the program recorded by the recording unit in real time to the network storage device simultaneously.

7. The recording device of claim 1, wherein the control unit deletes the recorded program stored in the local storing unit when the recorded program stored in the local storing unit is transmitted to the network storage device.

8. A method for recording a program, the method being implemented by a recording device having a local storing unit and communicating with a network storage device, the method comprising:
setting recording parameters in response to users' operations, wherein the recording parameters comprises at least an address of the network storage device;
recording the program according to the set recording parameters and transmitting the recorded program to the network storage device;
detecting whether the transmission unit is disconnected from the network storage device; and
storing the recorded program to the local storing unit when the transmission unit is disconnected from the network storage device, and transmitting the recorded program stored in the local storing unit to the network storage device when the transmission unit reconnects with the network storage device.

9. The method according to claim 8, wherein the recording parameters further comprises the desired channel corresponding to the program, a start time and an end time for recording the program, segment condition, storing name of the program.

10. The method according to claim 9, wherein the segment condition comprises a time period, and the program is recorded for the time period.

11. The method of claim 9, wherein the segment condition comprises a file size value, and the program is recorded in the file size value.

12. The method of claim 9, further comprising:
judging whether the time reaches the end time; and
stopping recording the program when the time reaches the end time When the time reaches the end time, the procedure goes to end.

13. The method of claim 11, further comprising:
deleting the recorded program stored in the local storing unit when the recorded program stored in the local storing unit is transmitted to the network storage device.
